(19) United States
(12) Patent Application Publication
(10) Pub. No.: US 2016/0271871 A1
(43) Pub. Date: Sep. 22, 2016

(54) 3D PRINTING DEVICE

(71) Applicant: ALT DESIGN CO., LTD., Taipei (TW)

(72) Inventors: YAO-JEN LEE, New Taipei (TW); MAO-CHUN CHEN, Changhua County (TW); HSIAO-YUAN HUANG, New Taipei (TW)

(21) Appl. No.: 14/659,636

(22) Filed: Mar. 17, 2015

(51) Int. Cl. B29C 67/00; B29C 47/00

(52) U.S. Cl. CPC B29C 67/0055; B29C 67/0088; B29C 47/0002; B33Y 10/00

(57) ABSTRACT

A 3D printer comprises a printer robot with a carrier, a control module that controls movement of the carrier by controlling the printer robot, and a printer head detachably connected to the carrier. The printer head comprises a casing, a nozzle for delivering a printing material to print a 3D object, and a button on the casing and electrically connected to the control module, wherein the printing material is delivered when the button is pressed.

### FIELD OF THE INVENTION

The present invention relates generally to 3D printer, more specifically a 3D printer with detachable printer head.

### BACKGROUND OF THE INVENTION

As printing technology evolve from 2D to 3D, many 3D printing technologies has been developed. To print a 3D object, a CAD (computer-aided design) file is needed, wherein the CAD file is converted to a printing information which is used by a 3D printer to print the 3D object.

In many cases, 3D printing is not user friendly to general consumers, because not everyone is able to create a 3D model by CAD. Therefore, printing from CAD file to a 3D object is not user friendly to users without computer 3D design skill.

In view of the above, a 3D printer which is able to print according to the printing information at the same time to be controlled by a user's hand to print is needed for more user friendly experience.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a schematic illustration of a 3D printer according to one embodiment of the present invention;

FIG. 2 is a schematic illustration of a detachable printer head according to one embodiment of the present invention;

FIG. 2A˜2D are schematic illustrations of different types of 3D printers with detachable printer head according to another embodiment of the present invention;

FIG. 3A˜3D are schematic illustrations of different types of detachable printer head attaching to a carrier according to one embodiment of the present invention;

FIG. 4A shows a cross-sectional illustration of the printer head according to one embodiment of the present invention;

FIG. 4B shows a cross-sectional illustration of the printer head in FIG. 4A according to one embodiment of the present invention;

FIG. 5 is an assembly drawing of the printer head according to one embodiment of the present invention;

FIG. 5A is a cross-sectional schematic illustration of a sliding bearing assembly according to one embodiment of the present invention;

FIG. 5B is an assembly drawing of the sliding bearing assembly according to one embodiment of the present invention;

FIG. 6A˜6B are schematic illustration of the printer head showing how a calibration is performed by the printer head according to another embodiment of the present invention;

FIG. 7 shows a method to use the 3D printer according to one embodiment of the present invention;

FIG. 8 schematically shows a delta 3D printer according to one embodiment of the present invention;

FIG. 8A schematically shows a linear guide connected a belt and a robot motor of a printer robot according to one embodiment of the present invention,

FIG. 8B schematically shows a platform of the 3D printer fixed by a U-shape clamp according to one embodiment of the present invention;

FIG. 8C schematically shows a belt adjuster connecting between the belt according to one embodiment of the present invention;

FIG. 8D schematically shows the belt adjuster comprising a top part and a bottom part according to one embodiment of the present invention;

FIG. 8E˜8F schematically shows the carrier being able to be installed with different types of printer head according to one embodiment of the present invention;

FIG. 8G schematically shows a material motor with a material stabilizer with a printer material in between according to one embodiment of the present invention;

FIG. 8H schematically shows the material stabilizer according to one embodiment of the present invention;

In accordance with common practice, the various described features are not drawn to scale and are drawn to emphasize features relevant to the present disclosure. Like reference characters denote like elements throughout the figures and text.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

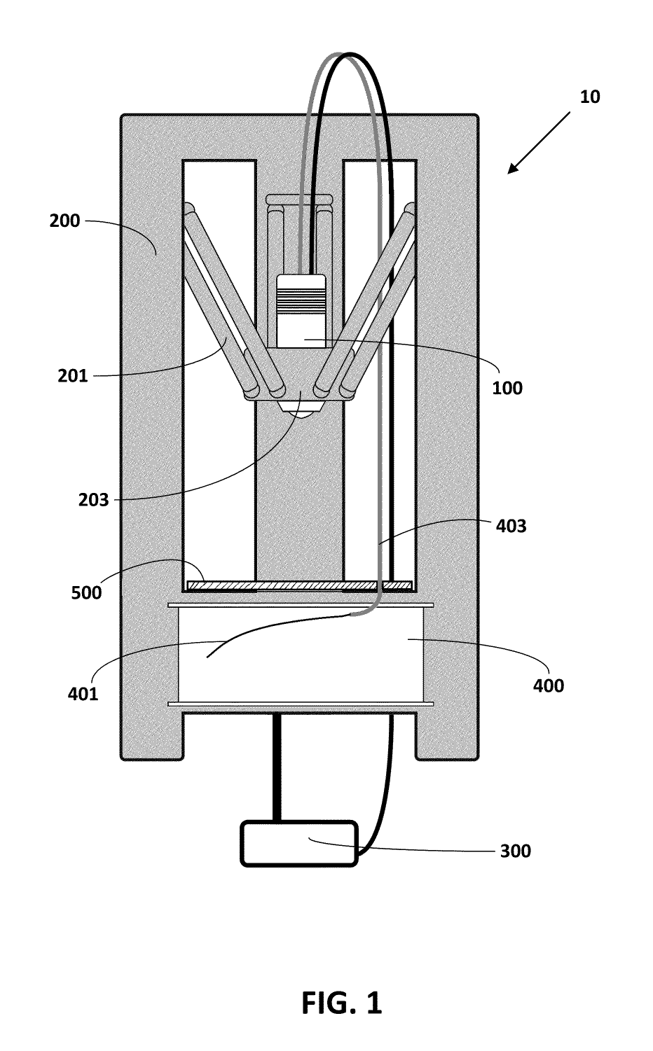

The description will be made as to the embodiments of the present invention in conjunction with the accompanying drawings in FIGS. 1 to 8H. Reference will be made to the drawing figures to describe the present invention in detail, wherein depicted elements are not necessarily shown to scale and wherein like or similar elements are designated by same or similar reference numeral through the several views and same or similar terminology.

FIG. 1 schematically shows a 3D printer 10 according to one embodiment of the present invention. The 3D printer 10 may comprise a printer head 100, a printer robot 200, a control module 300, a cartridge 400, and a platform 500. The printer robot 200 may comprise a plurality of arms 201, and a carrier 203 connected to all the arms 201. The carrier 203 may be connected to the arms 201 by magnetic ball joints, or any other types of detachable joints. The printer robot 200 may comprise a plurality of robot motors (not shown) for driving the movement of the plurality of arms 201, and the carrier 203 may move together with the plurality of arms. Therefore, the printer head 100 may be connected to the carrier 203 to be moved by the printer robot 200. The cartridge 400 may comprise a printing material 401 and a material motor (not shown), wherein the printing material 401 may be delivered to the printer head 100 by the material motor via a material tube 403, and the printer head 100 may deposit the printing material 401 on the platform 500 for printing a 3D object. The material tube 403 may connect between the printer head 100 and the cartridge 400, wherein the material tube 403 may be adapted to allow the printing material 401 to be delivered from the cartridge 400 to the printer head 100 smoothly. The control module 300 may be electrically connected to the robot motors 213 and the material motor, so the movement of the printer head 100 and the delivering of printer material 401 may be controlled by the control module 300. The 3D printer 10 may further comprise a power supply (not shown) which may be integrated in the control module 300, wherein the power supply may provide power to operate the 3D printer 10. Alternatively, the power supply may be connected to the 3D printer 10 externally via a power cable (not shown).

To print a 3D object by the 3D printer 10, a Printing information may be input to the control module 300 according to one embodiment of the present invention. The Printing information may comprise 3D printing information such as a path that the printer head 100 should move along, the speed of the printer head 100 should move, amount of printing material 401 should be deposited while moving along the path, rate of printing material 401 should be deposited, etc. After receiving the Printing information, the control module 300 may control the printer robot 200 to move the carrier 203 with the printer head 100 along the path according to the Printing information, at the same time the control module 300 may also control the cartridge 400 to deliver the printing material 401 to the printer head 100 which may deposit the printing material 401 according to the Printing information to form the 3D object.

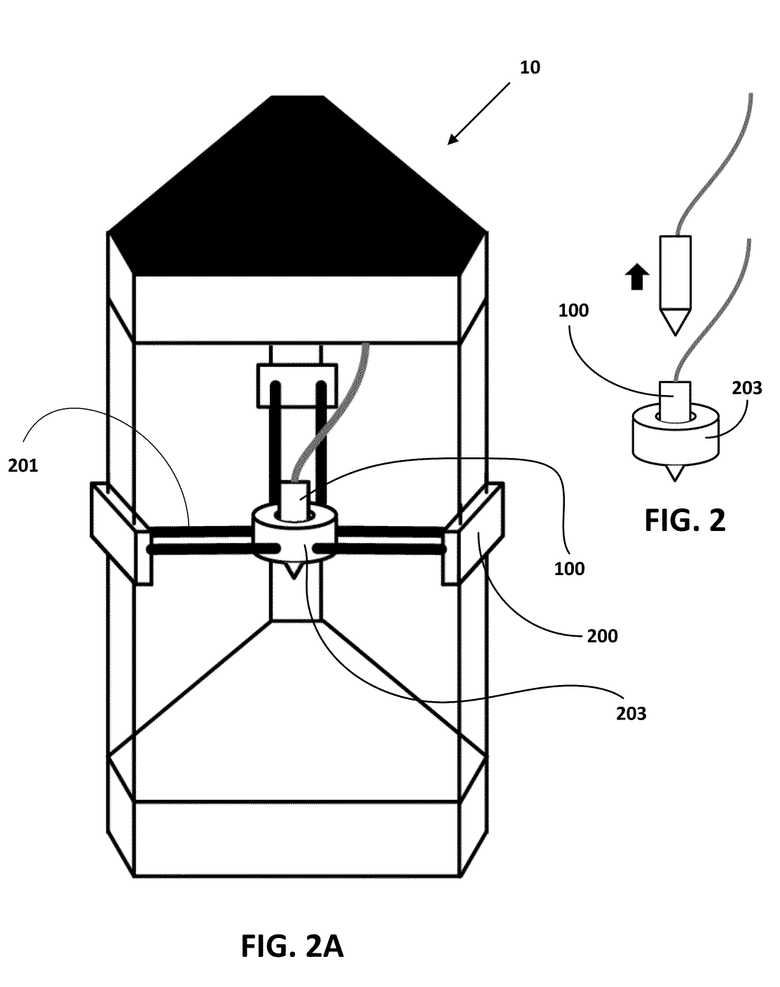

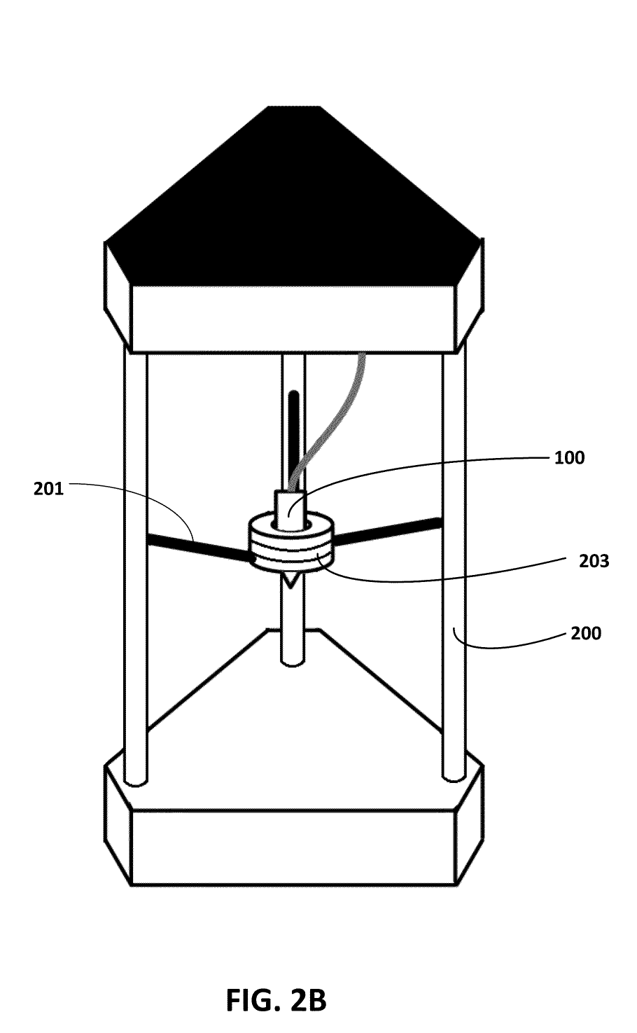

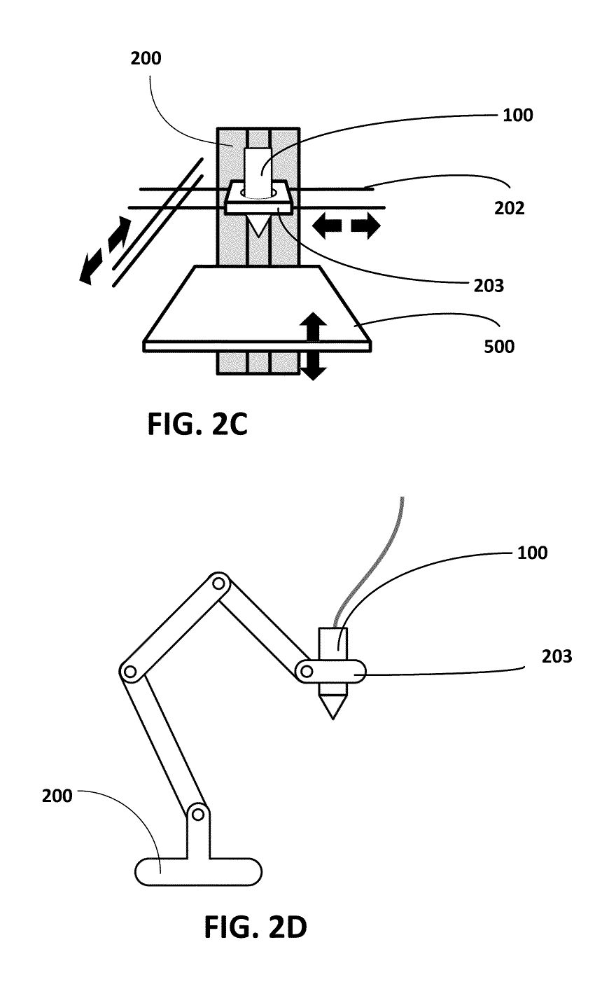

FIG. 2 schematically shows the printer head 100 which may be detachably connected to the carrier 203, and this approach may be further illustrated by FIG. 2A˜2D. Referring to FIG. 2A, the 3D printer 10 may comprise the printer head 100 and the printer robot 200, wherein the printer robot 200 may be a delta robot. The printer head 100 may be detachably connected to the carrier 203 as shown in FIG. 2. The printer robot 200 may move the printer head 100 via the plurality of arms 201 when the printer head 100 is connected to the carrier 203. Alternatively, a user may detach the printer head 100 from the carrier 203, and move the printer head 100 for printing by the user's hand. In other embodiments, the 3D printer 10 may comprise various different types of printer robot 200. For example, FIG. 2B shows a Simpson robot as the printer robot 200, wherein the same approach applies to the printer head 100 which may be detachably connected to the carrier 203. In FIG. 2C and FIG. 2D, the printer robot 200 may be regarded as Gantry robot and robotic arm respectively. In other embodiments, the printer head 100 may be fixed to the carrier 203, wherein the printer head 100 and the carrier 203 may be detached from the printer robot 200 together and to be used by the user's hand as whole. Alternatively, the printer head 100 may even be detachably connected to the printer robot 200 without the carrier 203. In view of the above, the detachable printer head 100 may be applicable to any 3D printers by different detachable connection methods.

Referring to FIG. 2C, the printer robot 200 may comprise a plurality of linear guides 202 according to one embodiment of the present invention. The carrier 203 may connect to the linear guides 202, wherein the linear guides 202 allows linear movement of the carrier 203, wherein at least one linear guide 202 is parallel to X axis and at least one linear guide 202 is parallel to Y axis. Thus, the plurality of linear guides 202 may control the position of the carrier 203 along X axis and/or Y axis. The Z axis movement of the carrier 203 is achieved by configuring the platform 500 to elevate or drop along the Z axis. Alternatively, the platform 500 may be stationary, and at least one of the linear guide 202 is parallel to the Z axis to allow the carrier 203 to move up or down. Therefore, the printer head 100 connected to the carrier 203 may be positioned along the X axis, Y axis and Z axis by moving along the linear guides 202. The linear guides 202 may be any forms of linear movement mechanism such as threaded rod with a threaded block, a linear rail with a roller, etc.

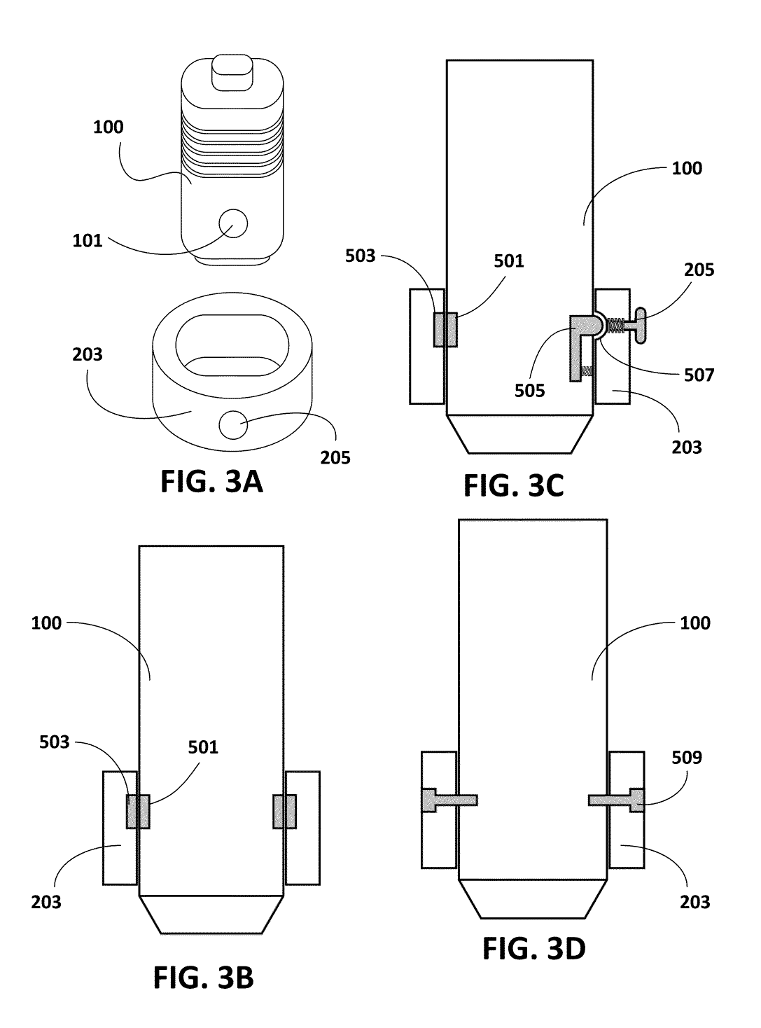

FIG. 3A˜3D schematically shows how the printer head 100 may be detachably connected to the carrier 203 by different detachable connection methods. In FIG. 3A, the printer head 100 may comprise a button 101, wherein the button 101 may actuate the printer head 100 to deposit the printing material 401. The carrier 203 may comprise a release button 205, wherein the release button 205 may be adapted to release the printer head 100 connected to the carrier 203. Thus, the user may detach the printer head 100 from the carrier 203 as mentioned before, and press the button 101 to deposit the printing material 401 for printing. FIG. 3B shows the printer head 100 may comprise at least one magnet 501, and the carrier 203 may comprise at least one magnet 503, wherein the printer head 100 may be detachably connected to the carrier 203 by the at least one magnet 501 and the at least one magnet 503. FIG. 3C shows a different type of detachable connection between the printer head 100 and the carrier 203, wherein the printer head 100 may comprise a magnet 501 and a spring tenon 505. The carrier 203 may comprise a magnet 503, a mortise 507, and the release button 205. In this case, the printer head 100 may be connected to the carrier 203 by magnetism and by the inserting the spring tenon 505 into the mortise 507. The printer head 100 may be detached from the carrier 203 as the user presses the release button 205 and pull the printer head 100 from the carrier 203, wherein the release button 205 may extend through the mortise 507 to push the spring tenon 505 out of the mortise 507. Alternatively, the printer head 100 may be connected to the carrier 203 by at least one screw 509, wherein the printer head 100 may either comprise a threaded hole or a nut. Hence, the printer head 100 may be detached from the carrier 203 by removing the at least one screw 509. It should be noted that the detachable connection methods applicable between the printer head 100 and the carrier 203 are not limited to the illustrations in FIG. 3A˜3D.

In one embodiment of the present invention, the button 101 may be a physical button for the user to press to deliver the printing material 401. Alternatively, the button 101 may be any other forms of actuator which is electrically connected to the control module 300 to be actuated by the user to deliver the printing material 401. For example, the button 101 may be a touch sensor, and the user may touch the touch sensor to deliver the printing material 401. In another embodiment of the present invention, the 3D printer 10 may further comprise a trigger (not shown) externally, and the trigger may be connected to the control module 300 to be used by the user to actuate the printer head 100 to deliver the printing material 401. For example, the trigger may be a pedal or any other forms of mechanical switch to be operated by the user to actuate the printer head 100 to deliver the printing material 401. Alternatively, the trigger may be a proximity sensor to be installed at the nozzle 105, wherein the trigger may be actuated when the printer head 100 is detached from the carrier 203 and moved close to a 3D model or any type of platform for printing. Thus, the user may hold the printer head 100 which is detached from the carrier 203 to print on anything without manually control the delivery of the printing material 401 while the proximity sensor automatically triggers to deliver the printing material 401 when the printer head 100 is held close to the 3D model or the platform.

In one embodiment of the present invention, the button 101 may be covered by the carrier 203 to avoid unintended actuation of the button 101 when the printer head 100 is connected to the carrier 203. In other embodiments, the carrier 203 or the printer head 100 may comprise a false-touch switch (not shown) to be connected to the control module 300, wherein the switch may be actuated when the printer head 100 is connected to the carrier 203. When the false-touch switch is actuated, the control module 300 automatically prevent unintended actuation of the button 101 by stopping the printing material 401 to be delivered by the printer head 100 when the button 101 is actuated.

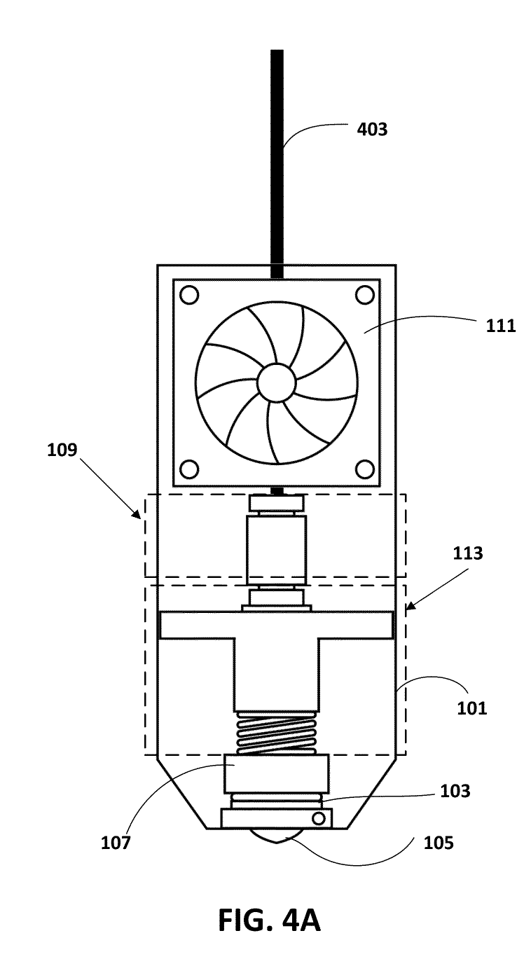

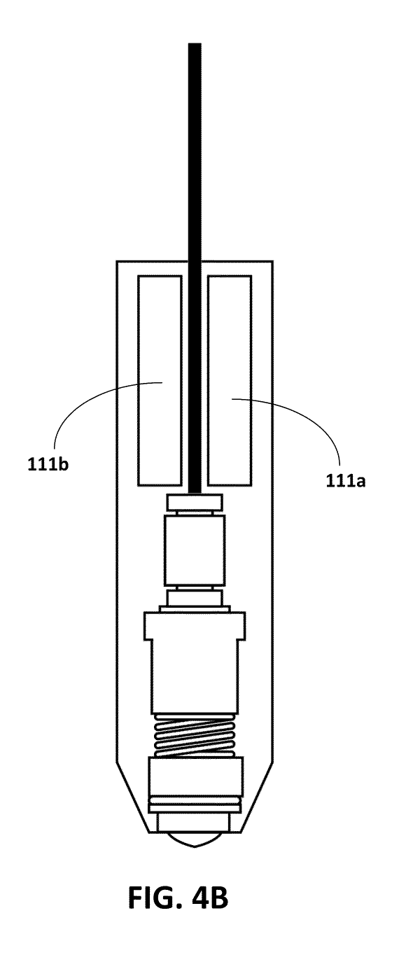

FIG. 4A schematically shows the cross section of the printer head 100. The printer head 100 may comprise a printer head casing 102 which may comprise one or more opening (not shown) at the side for air to pass, a heating plate 103, a nozzle 105, a heat sink 107, a material tube holder 109, a blower fan 111, a calibration module 113. In one embodiment of the present invention, the printing material 401 may be delivered to the printer head 100 via the material tube 403, wherein the material tube 403 may extend from the top of the printer head 100 into the printer head casing 102, and all the way down through the material tube holder 109, the calibration module 113, the heat sink 107, and the heating plate 103 to the nozzle 105. The material tube 403 may be fixed by the material tube holder 109, so the material tube 403 would not be drawn out of the printer head 100 while the printer robot 200 moving the printer head 100. The heating plate 103 may be electrically connected to the control module 300, wherein the control module 300 may control the heating plate 103 to heat up. The heat from the heating plate 103 may transfer to the nozzle 105, and the printing material 401 may be melted by the heat when it's delivered to the nozzle for depositing onto the platform 500. The blower fan 111 may suck air from the side of the printer head casing 102 into the printer head 100 and blow the air downwards from the top of the printer head 100 to the nozzle 105 and the air may exit from a hole/gap (not shown) at the side of the nozzle 105, wherein the air may cool the melted printing material 401 and harden the printing material 401 to form the 3D object. In other embodiments, heating plate 103 may be substituted with other forms of heating units such as coil or alike. In another embodiment of the present invention, the printer head 100 may comprise more than one blower fans 111. For example, in FIG. 4B, the printer head 100 may comprise two blower fans 111a and 111b. The heat sink 107 is adapted to dissipate the heat transferred from the heating plate 103, so the printing material 401 may not be melted by the heat before reaching the nozzle 105. At the same time, as the blower fan 111 blows from the top to the bottom, the air also takes away the heat to make sure the printing material 401 may be delivered to the nozzle without melting on the way. It should be noted that, other conventional heat dissipation method may be used such as water cooling. Alternatively, if the printing material 401 is not in solid state which requires melting at the nozzle 105, then the cooling from the blower fan 111 and the heat sink 107 may not be needed. Instead of the cooling and heating, the printer head 100 may comprise a solidification mechanism to solidify the printer material 401 which may be in fluid state.

In one embodiment of the present invention, the printer head 100 may be detached from the 3D printer 10 to work alone. For example, the printer head 100 may further comprise a power source (not shown) such as one or more battery, a material storage (not shown) comprising a material motor (not shown) and a micro-controller (not shown). The printing material 401 may be stored in the material storage. The power source and the button 101 may be connected to the micro-controller, and the micro-controller may be also connected to the material motor. Therefore, a user may detach the printer head 100 from the 3D printer 10 and press the button 101, and the micro-controller may then control the material motor to deliver the printing material 401 to the nozzle 105 to deposit the printer material 401 on the platform 500. Alternatively, the material motor may be installed externally on the 3D printer 10 instead to deliver the printing material 401. In another embodiment, the printer head 100 may be powered by both the battery and an external power source such as a cable from the 3D printer.

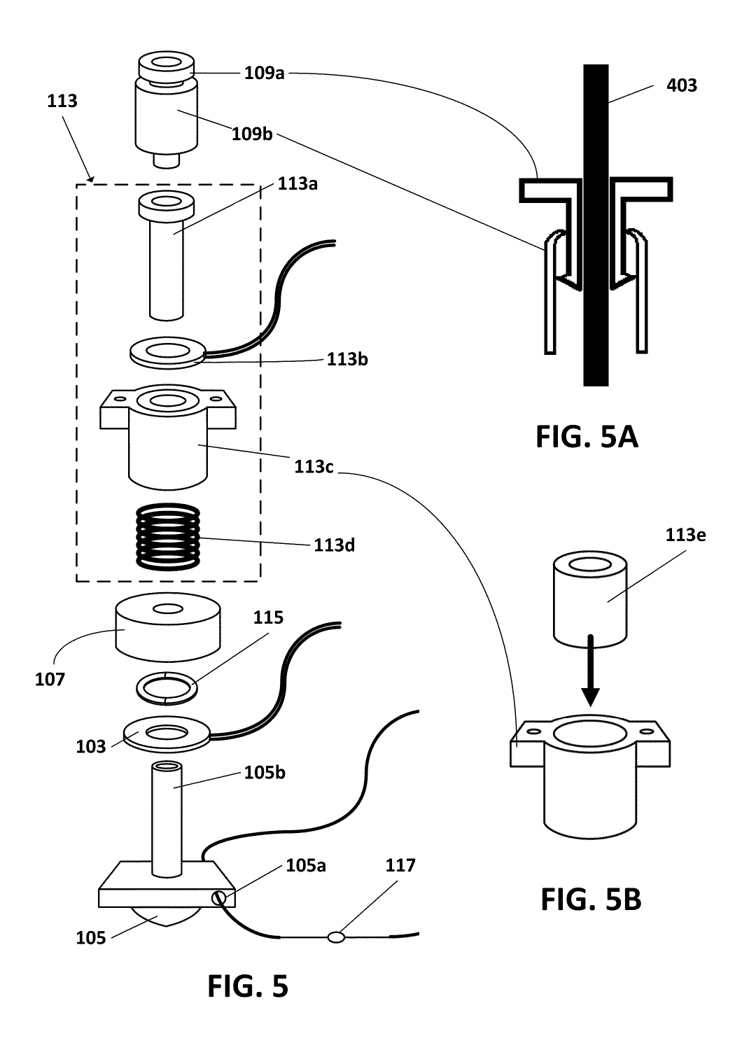

FIG. 5 schematically shows a printer head 100 the same as in FIG. 4A without showing the printer head casing 102 and the material tube 403, wherein the printer head 100 may further comprise a ring 115 to make sure the heat sink 107 is in touch with the heating plate 103, so the heat from the heating plate 103 may be transferred to the heat sink 107 without a gap. The nozzle 105 may comprise a hole 105a for placing a temperature sensor 117, wherein the temperature sensor 117 may be electrically connected to the control module 300. Thus, a temperature of the nozzle 105 may be sensed by the temperature sensor 117 and sent to the control module 300. Then, the control module 300 may control the heating plate 103 according to the temperature of the nozzle 105 to prevent over heating of the nozzle 105. The temperature sensor 117 may also ensure the nozzle 105 of the printer head 100 reaches a preset temperature before start printing a 3D object. While printing the 3D object, the control module 300 may control the heating plate 103 to keep the temperature of the nozzle 105 within a preset working range according to the temperature sensed by the temperature sensor 117.

In one embodiment of the present invention, the material tube holder 109 may be separated to a top holder 109a and a bottom holder 109b, wherein part of top holder 109a may be placed in the proximal end of the bottom holder 109b. As shown in FIG. 5A, when the material tube 403 is placed inside the material tube holder 109, the material tube 403 may be fixed by the material tube holder 109 as the top holder 109a is pulled away from the top of the top holder 109b, wherein the diameter of the distal end of the top holder 109a may be forced to contract by the bottom holder 109b. To remove the material tube 403 from the material tube holder 109, the top holder 109a may be pushed towards the bottom holder 109b, wherein the diameter of the distal end of the top holder 109a may restore as the force from the bottom holder 109b is removed. Alternatively, any other approaches of releasable fixation may be applied to the material tube 403 such as clamping.

In one embodiment of the present invention, the calibration module 113 may comprise a sliding shaft 113a which may be made of conductive material, a ring PCB board 113b which may be electrically connected to the control module 300 when the ring PCB board 113b is in touched with the sliding shaft 113a, a bearing holder 113c with a bearing 113e placed inside the bearing holder 113c as shown in FIG. 5B, and a spring 113d. The ring PCB board 113b may comprise a calibration circuit (not shown), wherein the calibration circuit may be connected to the control module 300 and the calibration circuit may only be completed with the control module 300 when the ring PCB board 113b is in touched with the conductive sliding shaft 113a. In other embodiments, the sliding shaft 113a may be made of non-conductive material, wherein the sliding shaft 113a may comprise a layer or a piece of conductive material at where the sliding shaft 113a touches the ring PCB board 113b to complete the calibration circuit. The sliding shaft 113a may be connected to the nozzle proximal end 105b with a threaded connection, wherein the ring PCB board 113b, the bearing holder 113c with the bearing 113e, the spring 113d, the heat sink 107, the ring 115, and the heating plate 103 may be placed in between the sliding shaft 113a and the nozzle 105 as shown in 6A. Alternatively, other types of mechanical connection may be used between the sliding shaft 113a and the nozzle proximal end 105b. The bearing holder 113c may be connected to the printer head casing 102, so the bearing holder 113c may move with the printer head casing 102 while the printer head 100 is calibrating. The ring PCB board 113b may be fixed to the bearing holder 113c, and move downwards together with the bearing holder 113c. When the bearing holder 113c moves downwards and compresses the spring 113d, the ring PCB board 113b is electrically disconnected from the control module 300. It should be noted that, the calibration module 113 may be substituted with other calibration mechanism which is adapted to connect and disconnect a calibration circuit such as a micro-switch, or other calibration mechanism which is configured to provide the control module 300 with different measurements such as force sensing resistors, light sensing probe, etc.

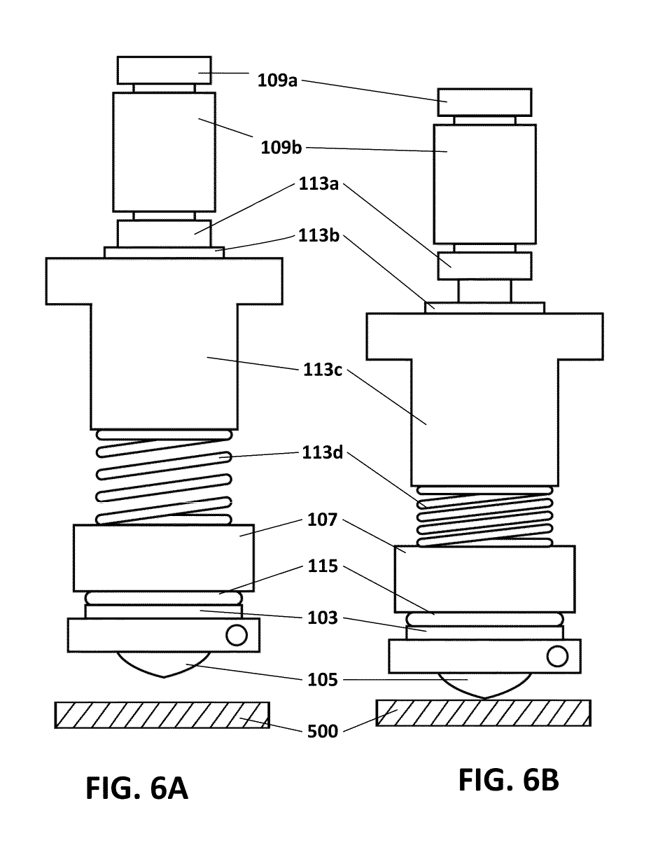

FIG. 6A schematically shows the printer head 100 as shown in FIG. 5 after assembling, and FIG. 6B schematically shows the printer head 100 as shown in FIG. 6A to be moved by the printer robot 200 against the platform 500. The difference between FIG. 6A and FIG. 6B is that FIG. 6A shows the printer head 100 before touching the platform 500, and FIG. 6B shows the printer head 100 when it's touching the platform 500.

To calibrate the 3D printer 10, the printer robot 200 may move the printer head 100 in FIG. 6A downwards to touch the platform 500 according to one embodiment of the present invention. After the nozzle 105 of the printer head 100 touches the platform 500 as the printer head 100 is moved by the printer robot 200, the printer robot 200 may move the printer head 100 further down towards the platform 500, wherein the spring 113d may start compressing. It should be noticed that, since the bearing holder 113c may be connected to the printer head casing 102 as mentioned, the printer head casing 102 and the bearing holder 113c may be moved further downwards by the printer robot 200 with the compressing spring 113d, while the sliding shaft 113a, the heat sink 107, the ring 115, the heating plate 103 and the nozzle 105 remaining stationary against the platform 500. As the bearing holder 113c with the ring PCB board 113b moving downwards, the calibration circuit of the ring PCB board 113b may be electrically disconnected from the control module 300 because the ring PCB board 113b is not in touch with the sliding shaft 113a, therefore the calibration circuit is broken. The control module 300 may control the printer robot 200 to stop moving the printer head 100 downwards as the calibration circuit is broken. A calibration of a 3D printer 10 is done to ensure the printing of the 3D object starts from a flat imaginary plane. Each time the printer head 100 touches the platform 500, the control module 300 may obtain a position of the point where the printer head 100 contacts the platform 500. At least three positions are required to obtain an imaginary plane, therefore the printer head 100 may be moved by the printer robot 200 to touch the platform at least three times. The more positions obtained by the control module 300, the flatter the imaginary plane may be set by the control module 300.

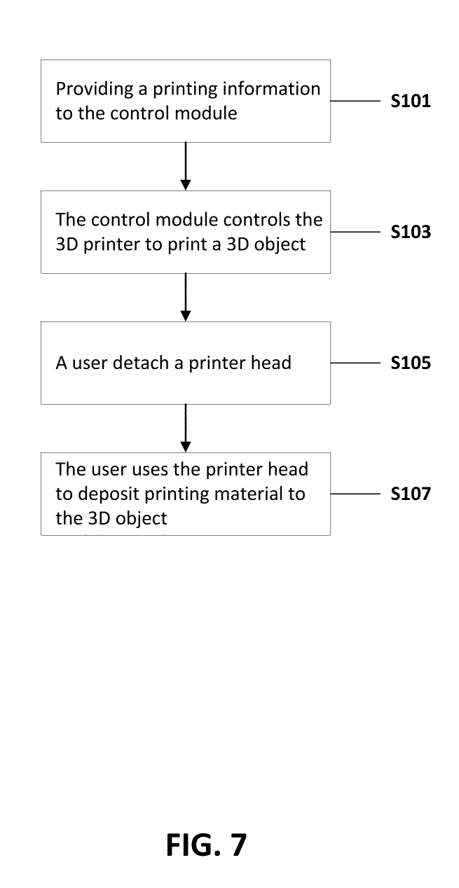

FIG. 7 shows a method for operating the 3D printer 10 according to one embodiment of the present invention. The method may comprise the following steps:

S101: Providing a printing information to the control module 300 of the 3D printer 10;

S103: The control module 300 may control the printer robot 200 to move the printer head 100 and the cartridge 400 to deliver the printer material 401 to the printer head 100 according to the printing information, so the 3D printer 10 may print a 3D object according to the printing information;

S105: The printer head 100 may be detached from the 3D printer 10 by a user;

S107: The user may move the printer head 100 with the user's hand and press the button 101 to deposit the printing material 401 on the 3D object with the printer head 100.

In one embodiment of the present invention, the printing information provided to the control module 300 in S101 may be through various methods, e.g. a data cable from a computer, a wireless connection from a computer, portable storage, a memory stick, a hard-disk, etc. The printing information may be produced by a slicer software integrated in a storage (not shown) of the control module 300. Alternatively, the printing information may also be provided by a 3D scanner which may scan a 3D object to obtain the corresponding printing information to the 3D object, wherein the printing information may then be sent to the 3D printer 10 to reproduce the scanned 3D object.

In one embodiment of the present invention, the printing information may be a G-code, a CAD file, or any other format of information that may be used to print a 3D object.

In another embodiment of the present invention, the printing information may be provided by inputting a CAD file to the control module of the 3D printer 10, wherein the control module 300 of the 3D printer 10 may convert the CAD file to a corresponding G-code needed to print the 3D object in the CAD file.

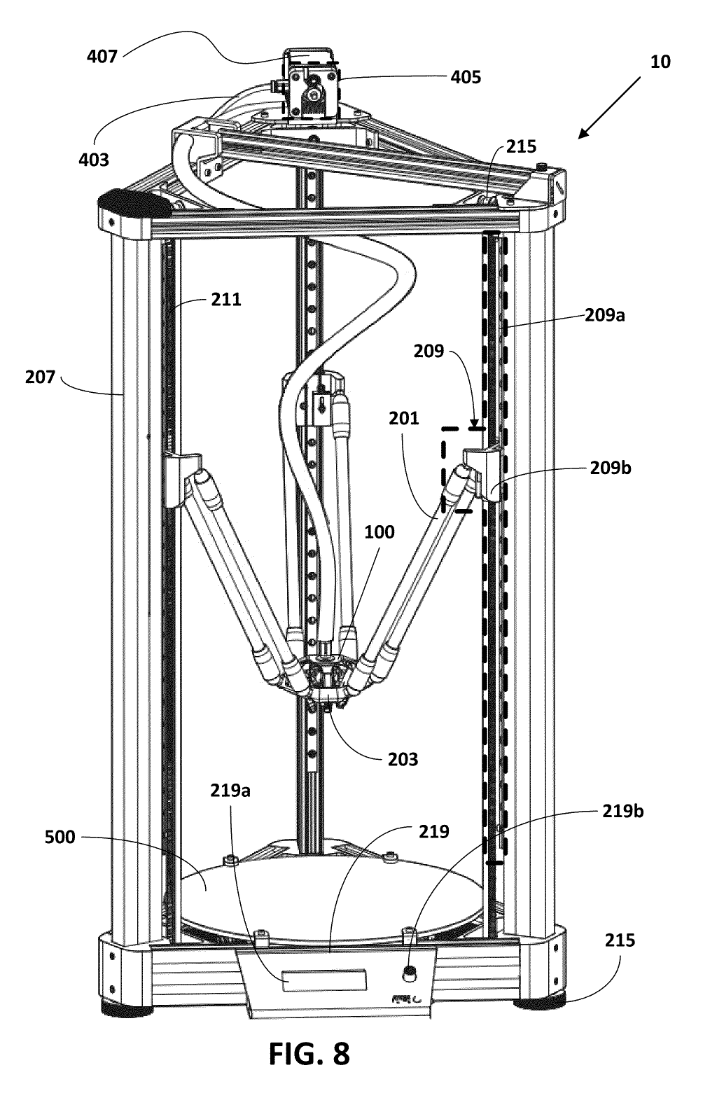

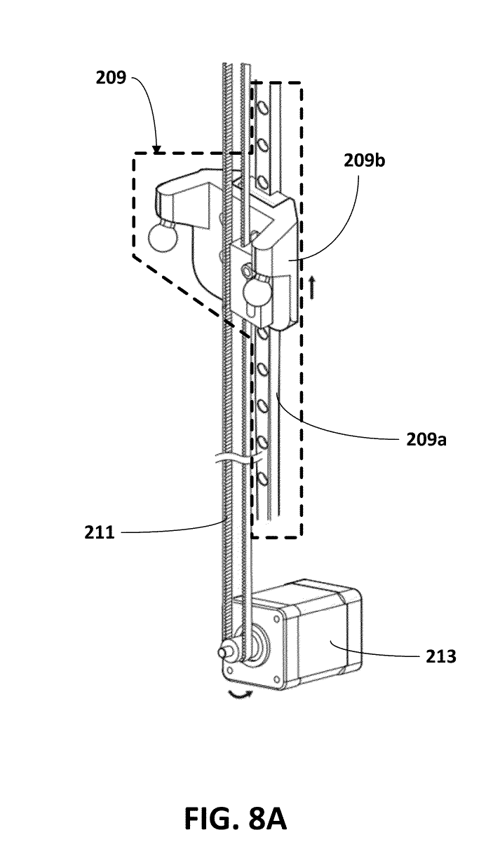

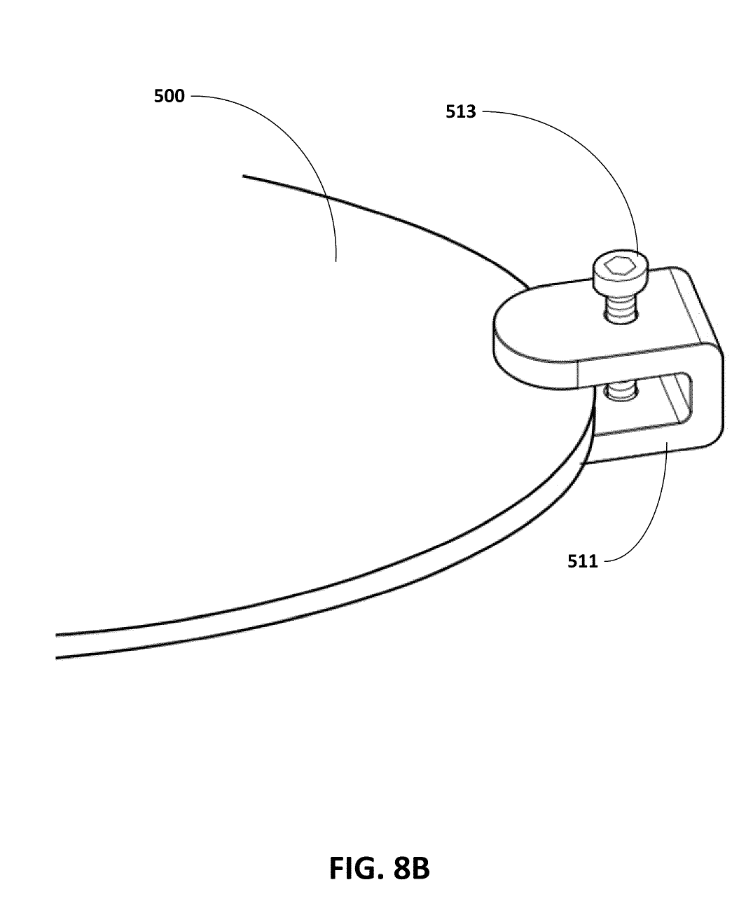

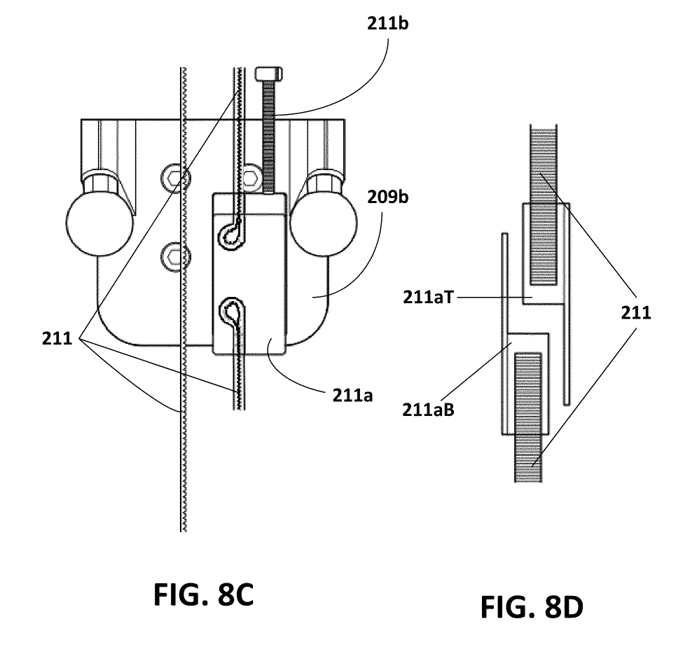

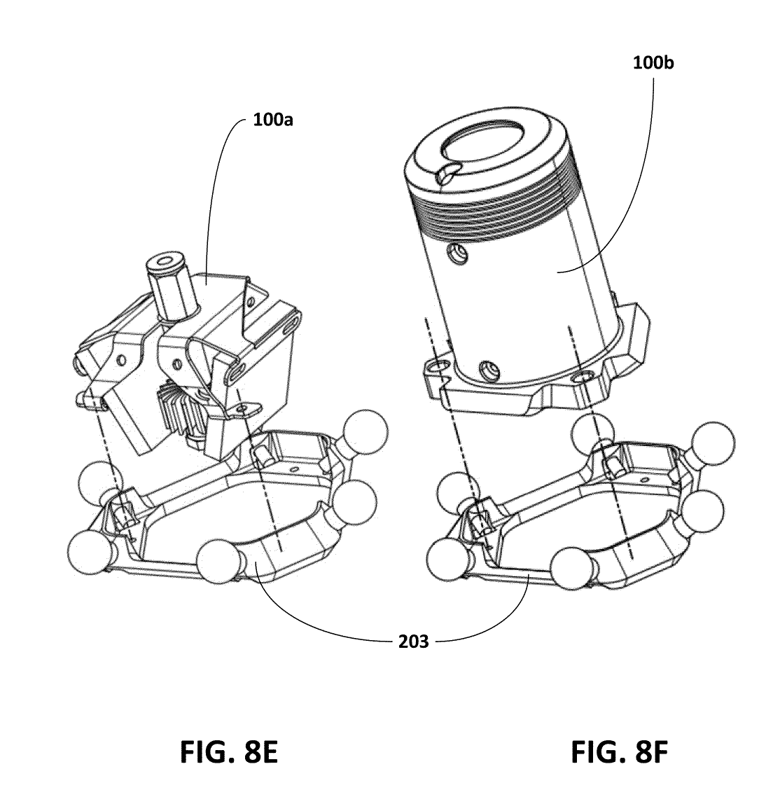

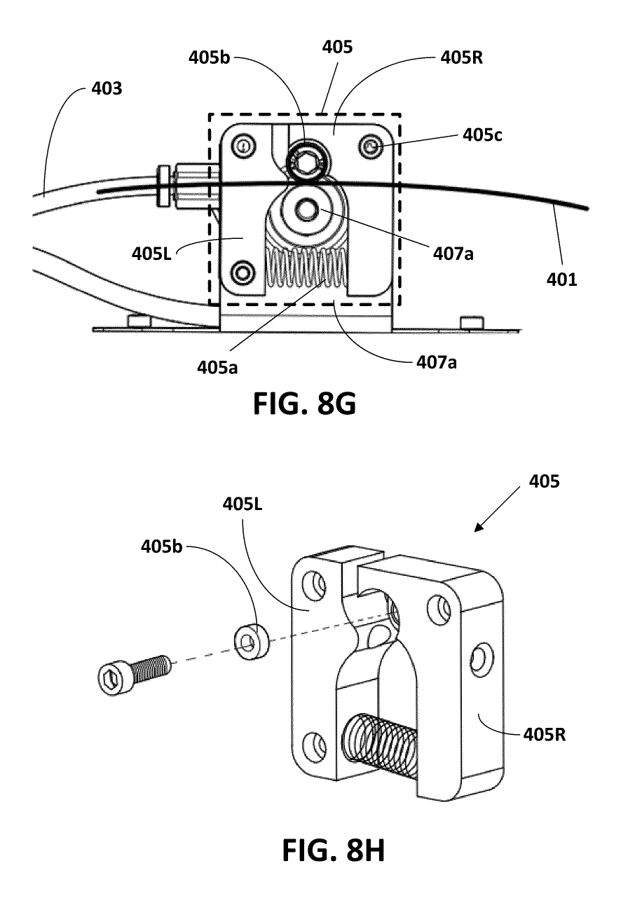

FIG. 8 schematically shows a 3D printer 10 with printer robot 200 which is a delta robot. The printer robot 200 may comprise three pairs of arms 201, the carrier 203, three poles 207, three linear guides 209, three belts 211, three belt bearings 215, and three robot motors (not shown), wherein the robot motors may be electrically connected to the control module 300. The linear guides 209 may each comprise a sliding rail 209a and a sliding block 209b. The pairs of arms 201 may each be connected in between the carrier 203 and each sliding block 209b by magnetic ball joints. Each of the linear guide 209 may be fixed on the side of each pole 207, wherein the poles 207 may be perpendicular to the platform 500. The linear guide 209 may be connected with the belt 211 and the robot motor 213 as shown in FIG. 8A, the belt 211 may be connected between the robot motor 213 and the belt bearing (not shown). The sliding block 209b may be connected to the belt 211, so the robot motor 213 may be operated by the control module 300 to move the sliding block 209b along the sliding rail 209a. The 3D printer 10 may further comprise a material motor 407 and a material stabilizer 405 installed on the top of the 3D printer 10, wherein the material motor 407 may be connected to the control module 300 to be controlled to deliver the printer material 401 through the material stabilizer 405 to ensure the smooth delivering of printer material 401 through the material tube 403 to the printer head 100.

While the user operates the 3D printer 10, the sliding blocks 209b may be sliding on the sliding rails 209a, and the pairs of arms 201 may be moved together with the sliding blocks 209b. Therefore, the position of the carrier 203 that is connected to the pairs of arm 201 may be controlled by the control module 300. At the top end of each sliding rail 209a, a micro-switch (not shown) may be installed and connected to the control module 300. When the sliding block 209bs reaches the top, the micro-switches may be actuated, so the control module 300 may stop moving the sliding blocks 209b upwards and define an upper limit for the Z axis movement of the printer robot 200, and an lower limit for the Z axis movement of the printer robot 200 may be manually configured in the control module 300 by assigning a distance from the upper limit. After all micro-switches are actuated, the control module 300 may then move the carrier 203 with the printer head 100 downwards along the Z axis until the printer head 100 touches the platform 500. After the printer head 100 touches the platform 500, the calibration module 113 of the printer head 100 may be actuated as shown in FIG. 6B, so a center point of the platform 500 may be defined. The range of XY plane movement of the printer robot 200 may be defined by manually configuring the control module 300 with a radius from the center point.

In one embodiment of the present invention, the platform 500 may be made of various types of heat-resistive material which may endure high temperature, such as glass, metal alloy, etc. As the printer head 100 may deposit melted printing material 401 on the platform 500, the temperature which the platform 500 needs to withstand must be equal or higher than the temperature of the melted printing material 401. For example, using PLA (Polyactide) as the printing material 401 to print a 3D object by the 3D printer 10, wherein the melting point of PLA is about 150-160° C. Therefore, the platform 500 may be made of heat-resistive material which may withstand temperature higher than 160° C. to ensure the platform 500 may not be broken or damaged by the high temperature printing material 401 deposited by the printer head 100. Heat-resistive material such as metal alloy, borosilicate glass, etc.

In one embodiment of the present invention, the poles 207 of the printer robot 200 may be made of various types of material which is durable and strong such as metal alloy or reinforced plastic, e.g. aluminum alloy, POM (Polyoxymethylene). As shown in FIG. 8, the printer robot 200 may further comprise a foot 215 under each of the pole 207 to support the 3D printer 10, wherein each foot 215 may comprise a stabilizer (not shown) beneath. The stabilizer may be made of various material which may absorb the vibration while the operation of the 3D printer 10, e.g. plastic foam, gel material, etc.

In one embodiment of the present invention, the printer robot 200 may comprise a threaded rod (not shown) and a threaded block (not shown) instead of the linear guide 209 and belt 211, wherein the threaded rod may be connected to and driven by the robot motor 213. As the robot motor 213 rotates the threaded rod, the threaded block connected to the threaded rod may be moved up or down. The pair of arms 201 may then be connected to the threaded block, so the carrier 203 may be driven by the robot motor 213.

In one embodiment of the present invention, the control module 300 of the 3D printer 10 may further comprise an on/off button (not shown), wherein the on/off button may be used to turn on or turn off the 3D printer 10. The control module 300 may further comprise a panel 219 with a display 219a and a control unit 219b on the panel 219. A user may use the control unit 219b to select various functions of the 3D printer 10, such as calibration, printing, etc. For example, the control module 300 of the 3D printer 10 may further comprise a slot (not shown) that may be a memory slot or an USB port for inserting a storage (not shown), wherein the storage may comprise a printing information. The user may use the control unit 219b to select the printing information from the storage to print a 3D object corresponding to the G-code. The storage may be a hard disk, a SD card, a USB memory, etc.

In one embodiment of the present invention, the platform 500 may be detachably fixed to the printer robot 200 by a U-shape clamp 511, wherein the platform 500 may be placed within the U-shape clamp 511 as shown in FIG. 8B, and a thread 513 may be inserted through the U-shape clamp 511 to fix the platform 500 to the U-shape clamp 511. The U-shape clamp 511 may be part of the printer robot 200 as a whole or be fixed to the printer robot 200 by the thread 513. In other embodiments, the platform 500 may be fixed to the printer robot 200 by any other types of connection such as magnetism, latch, etc.

In one embodiment of the present invention, the belt 211 may be connected to the sliding block 209b with a belt adjuster 211a in between as shown in FIG. 8C. The belt 211 may comprise two terminals which may connect to top and bottom of the belt adjuster 211a while surrounding the robot motor (not shown) and the belt bearing (not shown) to form a close loop, so the robot motor may rotate to move sliding block 209b along the sliding rail (not shown) via moving the belt adjuster 211a. The belt adjuster 211a may be separated into a top part 211aT and a bottom part 211aB as in shown FIG. 8D, wherein the two terminals of the belt 211 may be connected to the top part 211aT and the bottom part 211aB. A thread 211b may be used to connect the top part 211aT and the bottom part 211aB as shown in FIG. 8C, wherein the thread 211b may be turned to adjust the distance between the top part 211aT and the bottom part 211aB. Therefore the tension of the close loop surrounding the robot motor and the belt bearing may be adjusted by turning the thread 211b to vary the distance between the top part 211aT and bottom part 211aB of the belt adjuster 211a. Alternatively, the belt adjuster 211a may be one piece with a releasable clamp to adjust one of the terminal of the belt 211 in order to adjust the tension of the close loop.

In one embodiment of the present invention, the printer head 100 of the 3D printer 10 may be exchangeable to provide different functions of the 3D printer 10. In FIG. 8E, a deposition printer head 100a may be installed on the carrier 203 to print a 3D object. In the other hand, a laser printer head 100b may be installed on the carrier 203 to engrave a 3D object. In other embodiments, various different types of printer head 100 may be applied to the carrier 203 such as 3D scanner, 3D polisher, etc.

FIG. 8G shows an assembly of the material motor 407 and the material stabilizer 405 in a front view according to one embodiment of the present invention. The material stabilizer 405 may have a left part 405L and a right part 405R as shown in FIG. 8H, wherein the left part 405L may be fixed to the front of the material motor 407 to be stationary, and the right part 405R may be fixed to the front of the material motor 407 to be movable. In between the left part 405L and the right part 405R of the material stabilizer 405, a spring 405a may be connected in between. A material bearing 405b may be fixed to the right part 405R of the material stabilizer 405 by a thread as shown in FIG. 8H. As the material stabilizer 405 may be fixed to the front of the material motor 407, a gear 407a of the material motor 407 may be within the material stabilizer 405 as shown in FIG. 8G, wherein the material bearing 405b may be pushed by the spring 405a against the gear 407a while the right part 405R of the material stabilizer 407 being movable around a pivot point 405c. The printer material 401 may be placed between the gear 407a and the material bearing 405b, and the material motor 407 may operate to rotate the gear 407a to push the printer material 401 against the material bearing 405b and deliver the printing material 401 through the material tube 403.

Previous descriptions are only embodiments of the present invention and are not intended to limit the scope of the present invention. Many variations and modifications according to the claims and specification of the disclosure are still within the scope of the claimed invention. In addition, each of the embodiments and claims does not have to achieve all the advantages or characteristics disclosed. Moreover, the abstract and the title only serve to facilitate searching patent documents and are not intended in any way to limit the scope of the claimed invention.

What is claimed is:

1. A 3D printer, comprising:
a printer robot with a carrier;
a control module that controls movement of the carrier by controlling the printer robot; and
a printer head detachably connected to the carrier, comprising:
a casing;
a nozzle for delivering a printing material to print a 3D object;
a button on the casing and electrically connected to the control module,
wherein the printing material is delivered when the button is pressed.

2. The 3D printer according to claim 1, wherein the printer head further comprises a heating unit electrically connected to the control module for heating the printing material delivered through the nozzle.

3. The 3D printer according to claim 2, wherein the printer head further comprises a temperature sensor configured to sense the temperature of the nozzle and to send the sensed temperature to the control module for controlling the heating unit.

4. The 3D printer according to claim 2, wherein the printer head further comprises a cooling unit electrically connected to the control module for cooling the printer head.

5. The 3D printer according to claim 4, wherein the cooling unit comprises a fan configured to blow and cool the heated printing material outputted from the nozzle.

6. The 3D printer according to claim 4, wherein the cooling unit comprises a heat sink which dissipates the heat generated from the heating unit of the printer head.

7. The 3D printer according to claim 1, wherein the printer head and the carrier are detachably connected to each other by magnetism.

8. The 3D printer according to claim 1, wherein the printer robot further comprises a plurality of arms, and the carrier is connected to the plurality of arms by magnetism.

9. The 3D printer according to claim 1, wherein the printer robot further comprises a plurality of linear guides for positioning the carrier.

10. The 3D printer according to claim 1, wherein the printer robot further comprise at least one motors for controlling the position of the printer head.

11. A method for printing a 3D object by using a 3D printer having a detachable printer head, comprising:
S1: providing printing information of the 3D object to a control module of the 3D printer;
S2: controlling the 3D printer to print the 3D object based on the printing information of the 3D object;
S3: detaching the printer head from the 3D printer; and
S4: pressing a button on the printer head to deposit a printing material on the 3D object.

12. The method according to claim 11, wherein the 3D printer comprises a plurality of arms for controlling the position of the printer head.

13. The method according to claim 11, wherein the printing information of the 3D object is provided to the control module through wired or wireless communication.

14. The method according to claim 11, wherein the 3D printer comprises a slot to receive the printing information of the 3D object.

15. The method according to claim 11, wherein the printing information of the 3D object comprises a G-code or a CAD file.

16. The method according to claim 11, wherein the printing information of the 3D object is provided by a 3D scanner.

17. A handheld printing apparatus for printing a 3D object, comprising:
a nozzle for depositing a printing material to print the 3D object;
a heating unit for melting the printing material which goes through the nozzle;
a casing having a button and detachably connected to a 3D printer having a printer robot, wherein the button is configured to be pressed to cause the printing apparatus to output and deposit the printing material.

18. The printing apparatus according to claim 17, further comprising a heat sink for dissipating the heat generated from the heating unit.

19. The printing apparatus according to claim 18, further comprising a fan for cooling both the printing apparatus and the melted printing material.

20. The printing apparatus according to claim 17, further comprising a temperature sensor configured to sense the temperature of the nozzle and to send the sensed temperature to the control module for controlling the heating unit.

21. The printing apparatus according to claim 17, wherein the casing is detachably connected to a 3D printer by at least one magnet.
